(19) United States
(12) Patent Application Publication
(10) Pub. No.: US 2026/0126690 A1
(43) Pub. Date: May 7, 2026

(54) ARRAY SUBSTRATE AND DISPLAY PANEL

(71) Applicant: WUHAN CHINA STAR OPTOELECTRONICS TECHNOLOGY CO., LTD., Wuhan, Hubei (CN)

(72) Inventors: Xiuyan LI, Wuhan, Hubei (CN); Fei AI, Wuhan, Hubei (CN); Chao TIAN, Wuhan, Hubei (CN)

(21) Appl. No.: 18/992,293

(22) PCT Filed: Nov. 8, 2024
(86) PCT No.: PCT/CN2024/130695

§ 371 Date: Jan. 8, 2025

(30) Foreign Application Priority Data
Nov. 4, 2024 (CN) 202411563552.3

(51) Int. Cl. G02F 1/1362

(52) U.S. Cl. CPC G02F 1/136218; G02F 1/13629; G02F 2201/121; G02F 2201/122; G02F 2201/123

(57) ABSTRACT

An array substrate and a display panel are provided by the present disclosure. A light-shielding electrode of the array substrate is located outside pixel opening regions. The light-shielding electrode is configured to cooperate with a common electrode and form at least some slits. The common electrode includes a plurality of first electrode lines arranged at a different layer from the light-shielding electrode. At least one of the first electrode lines passes through at least one of the pixel opening regions, so as to form at least two slits in the at least one of the pixel opening regions with the light-shielding electrode.

### TECHNICAL FIELD

The present disclosure relates to a technical field of display, and in particular to an array substrate and a display panel.

### BACKGROUND

With the development of display technologies, liquid crystal display (LCD) panels have been widely used in many electronic products, such as mobile phones and tablet computers. Due to increasing demands from users for the electronic products, the electronic products nowadays are constantly developing towards high transmittance and high resolution. A liquid crystal display panel generally includes an array substrate, a color filter substrate, and a liquid crystal layer sandwiched between the array substrate and the color filter substrate. With the improvement of resolution, more thin film transistor devices and signal lines need to be disposed on the array substrate, resulting in a decrease in an area of an opening area, thereby affecting the improvement of transmittance.

Therefore, how to achieve high transmittance while realizing high resolution of the display panel has become an urgent problem to be solved.

### SUMMARY

An array substrate and a display panel are provided by the present disclosure to achieve high transmittance while realizing high resolution of the display panel.

The technical proposals provided by the present disclosure are as follows:

In one aspect, an array substrate is provided by the present disclosure. The array substrate includes:
a substrate;
a plurality of data lines arranged on the substrate base at intervals along a first direction;
a plurality of scanning lines arranged on the substrate at intervals along a second direction, where the second direction is different from the first direction, and the plurality of scanning lines intersect the plurality of data lines to define a plurality of pixel opening regions;
a plurality of pixel electrodes disposed on the substrate, where each of the pixel electrodes is located in a corresponding one of the pixel opening regions;
a common electrode patterned and disposed on the substrate, where the common electrode is spaced apart from the pixel electrodes in a thickness direction of the array substrate; and
a light-shielding electrode patterned and disposed on the data lines and/or the scanning lines and located outside the pixel opening regions, where the light-shielding electrode is configured to cooperate with the common electrode to form at least some slits.

The common electrode includes a plurality of first electrode lines arranged at a different layer from the light-shielding electrode, and at least one of the first electrode lines passes through at least one of the pixel opening regions in a top view angle of the array substrate.

In another aspect, a display panel is further provided by the present disclosure. The display panel includes an array substrate. The array substrate includes:
a substrate;
a plurality of data lines arranged on the substrate at intervals along a first direction;
a plurality of scanning lines arranged on the substrate at intervals along a second direction, where the second direction is different from the first direction, and the plurality of scanning lines intersect the plurality of data lines to define a plurality of pixel opening regions;
a plurality of pixel electrodes disposed on the substrate, where each of the pixel electrodes is located in a corresponding one of the pixel opening regions;
a common electrode patterned and disposed on the substrate in a pattern, where the common electrode is spaced apart from the pixel electrodes in a thickness direction of the array substrate; and
a light-shielding electrode patterned and disposed on the data lines and/or the scanning lines and located outside the pixel opening regions, where the light-shielding electrode is configured to cooperate with the common electrode to form at least some slits.

The common electrode includes a plurality of first electrode lines arranged at a different layer from the light-shielding electrode, and at least one of the first electrode lines passes through at least one of the pixel opening regions in a top view angle of the array substrate.

### BRIEF DESCRIPTION OF THE DRAWINGS

To describe the technical proposals of the embodiments of the present disclosure more clearly, the following briefly introduces the accompanying drawings used in the description of the embodiments of the present disclosure. Apparently, the accompanying drawings described below illustrate only some exemplary embodiments of the present disclosure, and persons ordinarily skilled in the art may derive other drawings from the drawings without making creative efforts.

FIG. 1 is a schematic partial plan structural view of an array substrate according to some embodiments of the present disclosure.

FIG. 2 is a first schematic plan structural view of a common electrode and a light-shielding electrode according to some embodiments of the present disclosure.

FIG. 3 is a schematic cross-sectional structural view of the array substrate along a direction shown as M-M′ in FIG. 2.

FIG. 4 is a schematic cross-sectional structural view of the array substrate along a direction shown as N-N+ in FIG. 2.

FIG. 5 is a second schematic plan structural view of the common electrode and the light-shielding electrode according to some embodiments of the present disclosure.

FIG. 6 is a third schematic plan structural view of the common electrode and the light-shielding electrode according to some embodiments of the present disclosure.

FIG. 7 is a fourth schematic plan structural view of the common electrode and the light-shielding electrode according to some embodiments of the present disclosure.

FIG. 8 is a schematic cross-sectional structural view of the array substrate along a direction shown as S-S′ in FIG. 7.

FIG. 9 is a schematic cross-sectional structural view of the array substrate along a direction shown as T-T′ in FIG. 7.

FIG. 10 is a fifth schematic plan structural view of the common electrode and the light-shielding electrode according to some embodiments of the present disclosure.

FIG. 11 is a sixth schematic plan structural view of the common electrode and the light-shielding electrode according to some embodiments of the present disclosure.

FIG. 12 is a schematic plan structural view of a common electrode in the related art.

FIG. 13 is a seventh schematic plan structural view of the common electrode and the light-shielding electrode according to some embodiments of the present disclosure.

FIG. 14 is an eighth schematic plan structural view of the common electrode and the light-shielding electrode according to some embodiments of the present disclosure.

FIG. 15 is a ninth schematic plan structural view of the common electrode and the light-shielding electrode according to some embodiments of the present disclosure.

FIG. 16 is a schematic plan structural view of the common electrode according to some embodiments of the present disclosure.

FIG. 17 is a tenth schematic plan structural view of the common electrode and the light-shielding electrode according to some embodiments of the present disclosure.

FIG. 18 is an eleventh schematic plan structural view of the common electrode and the light-shielding electrode according to some embodiments of the present disclosure.

FIG. 19 is another schematic plan structural view of the common electrode according to some embodiments of the present disclosure.

FIG. 20 is a twelfth schematic plan structural view of the common electrode and the light-shielding electrode according to some embodiments of the present disclosure.

FIG. 21 is a thirteenth schematic plan structural view of the common electrode and the light-shielding electrode according to some embodiments of the present disclosure.

FIG. 22 is a schematic partial cross-sectional structural view of a display panel according to some embodiments of the present disclosure.

### DETAILED DESCRIPTION

The following description of every embodiment with reference to the accompanying drawings is used to exemplify a specific embodiment which may be carried out in the present disclosure. Directional terms mentioned in the present disclosure, such as “top”, “bottom”, “front”, “back”, “left”, “right”, “inside”, “outside”, “side” etc., are only used with reference to orientations of the accompanying drawings. Therefore, the used directional terms are intended to illustrate, but not to limit, the present disclosure. In the accompanying drawings, units with similar structures are indicated by a same number. In the accompanying drawings, the thickness of some layers and regions is exaggerated for clarity of understanding and ease of description. That is, the dimension and thickness of each of the elements in the accompanying drawings are arbitrarily shown, but the present disclosure is not limited thereto.

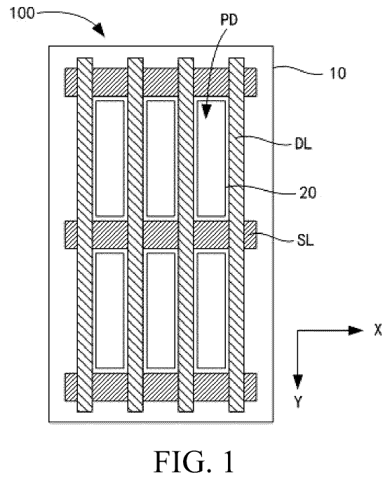

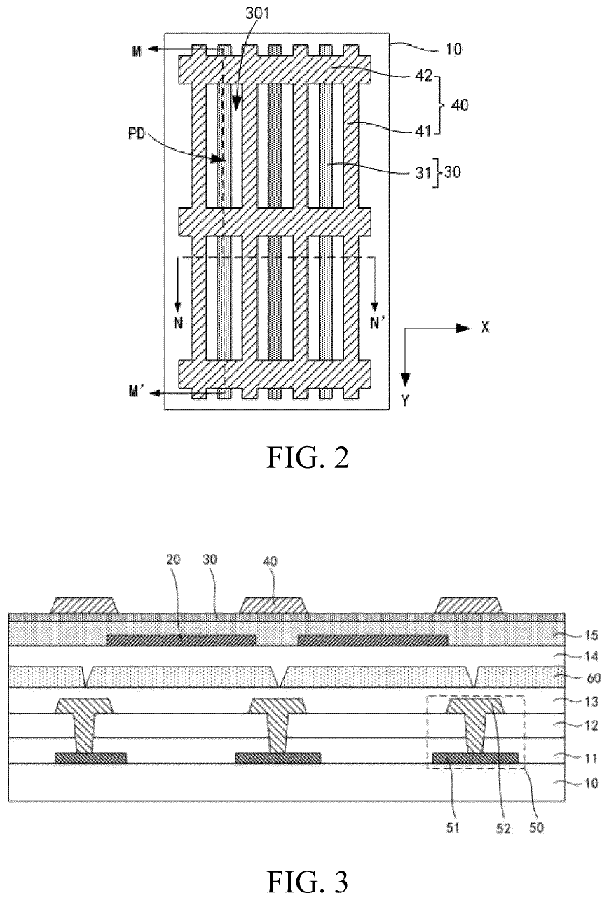

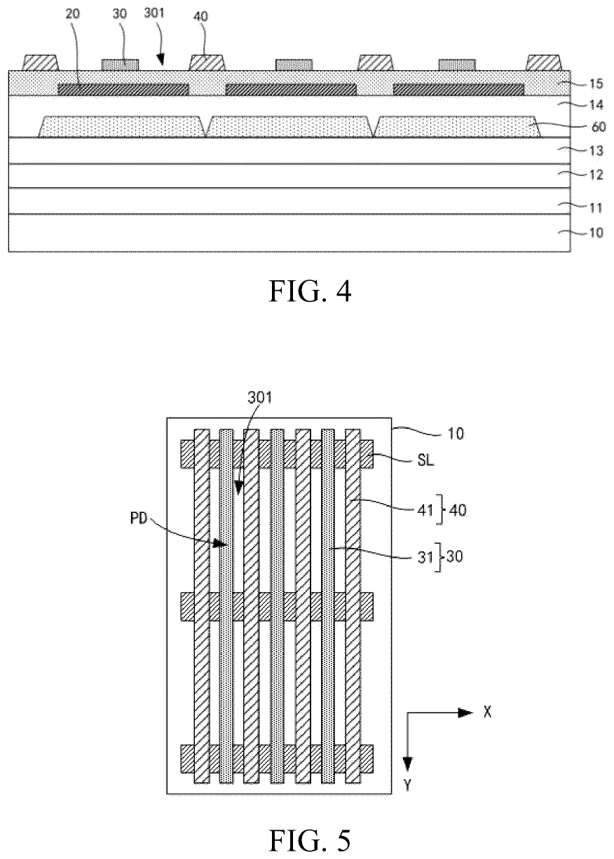

Referring to FIG. 1 to FIG. 4, FIG. 1 is a schematic partial plan structural view of an array substrate according to some embodiments of the present disclosure. FIG. 2 is a first schematic plan structural view of a common electrode and a light-shielding electrode according to some embodiments of the present disclosure. FIG. 3 is a schematic cross-sectional structural view of the array substrate along a direction shown as M-M′ in FIG. 2. FIG. 4 is a schematic cross-sectional structural view of the array substrate along a direction shown as N-N′ in FIG. 2. An array substrate 100 includes a substrate 10 and a plurality of data lines DL, a plurality of scanning lines SL, a plurality of pixel electrodes 20, a common electrode 30, and a light-shielding electrode 40, which are arranged on the substrate 10.

Referring to FIG. 1, the plurality of data lines DL are arranged on the substrate 10 at intervals along a first direction X. Each of the data lines DL extends along a second direction Y. The plurality of scanning lines SL are arranged on the substrate 10 at intervals along the second direction Y. Each of the scanning lines SL extends along the first direction X. Intersection of the plurality of scanning lines SL and the plurality of data lines DL defines a plurality of pixel opening regions PD. Each of the pixel opening regions PD is provided with one sub-pixel. The second direction Y is different from the first direction X. An included angle between the first direction X and the second direction Y is greater than 0° and less than or equal to 90°. When the included angle between the first direction X and the second direction Y is 90°, the first direction X is perpendicular to the second direction Y. In this situation, the first direction X may be a row direction and the second direction Y may be a column direction.

The plurality of pixel electrodes 20 are disposed on the substrate 10. Each of the pixel electrodes 20 is located in a corresponding one of the pixel opening regions PD, i.e., each of the pixel opening regions PD is provided with a corresponding one of the pixel electrodes 20. Each of the pixel electrodes 20 can be characterized as one sub-pixel. The pixel electrodes 20 in adjacent two of the pixel opening regions PD are arranged at intervals and insulated from each other. It should be noted that the pixel electrodes 20 illustrated in FIG. 1 are used to illustrate a correspondence relationship between the pixel electrodes 20 and the pixel opening regions PD, and do not constitute a specific limitation on structures and positions of the pixel electrodes 20. The pixel electrodes 20 of the present disclosure may further partially cover the data lines DL and/or the scanning lines SL. Moreover, each of the pixel electrodes 20 may further include a plurality of trunk electrodes, branch electrodes, etc., so as to form a plurality of slits on each of the pixel electrodes 20. The slits on the pixel electrodes 20 are hollow patterns formed on the pixel electrodes 20.

Combining to refer to FIG. 1 and FIG. 2, the common electrode 30 is disposed on the substrate 10 in a pattern. The common electrode 30 is spaced apart from the pixel electrodes 20. A horizontal electric field may be formed between the pixel electrodes 20 and the common electrode 30 to drive liquid crystal molecules to deflect. A fact that the pixel electrodes 20 is spaced apart from the common electrode 30 refers to a correspondence relationship of spatial positions of the pixel electrodes 20 and the common electrode 30 in a thickness direction of the array substrate 100. For example, the common electrode 30 may be located below the pixel electrodes 20, or the common electrode 30 may also be located above the pixel electrodes 20. Moreover, the common electrode 30 is insulated from the pixel electrodes 20. The thickness direction of the array substrate 100 is a direction perpendicular to a horizontal plane where the substrate 10 is located. A material of the common electrode 30 may be the same as a material of the pixel electrodes 20. For example, the material of the pixel electrode 20 includes a transparent conductive material such as indium tin oxide.

The embodiments of the present disclosure are illustrated by taking the common electrode 30 patterned and disposed on the pixel electrodes 20 in the pattern as an example. The common electrode 30 is spaced apart from the pixel electrodes 20 in the thickness direction of the array substrate 100. A part of the common electrode 30 is located in the pixel opening regions PD and is disposed opposite to the pixel electrodes 20. The common electrode 30 located in the pixel opening regions PD forms at least two slits 301 in the corresponding one of the pixel opening regions PD.

The light-shielding electrode 40 is patterned and disposed on the data lines DL and/or the scanning lines SL and located outside the pixel opening regions PD. The light-shielding electrode 40 is configured to cooperate with the common electrode 30 to form at least some of the slits 301. The common electrode 30 includes a plurality of first electrode lines 31 arranged at a different layer from the light-shielding electrode 40. At least one of the first electrode lines 31 passes through the corresponding one of the pixel opening regions PD in a top view angle of the array substrate, and thus the least one of the first electrode lines 31 and the light-shielding electrode 40 form at least two silts 30 in the corresponding one of the pixel opening regions PD. Therefore, a range of a liquid crystal dark region may be reduced and a bright region is enlarged, thereby improving the transmittance. Moreover, the slits are formed by the light shielding electrode 40 and the common electrode 30 arranged in different layers, and thus morphology at corners of the slits can be optimized to be relatively clear, thereby improving a problem of local liquid crystal disorder.

Optionally, the light-shielding electrode 40 is located on a side of the pixel electrodes 20 away from the substrate 10. The light-shielding electrode 40 is configured to shield the data lines DL and/or the scanning lines SL from light, thereby preventing the data lines DL and the scanning lines SL from being reflected. A material of the light-shielding electrode 40 includes at least one of materials having light-shielding and conductive properties, such as molybdenum and molybdenum oxide. It should be noted that in the present disclosure, a fact that one structure is above or below another structure and a fact that one structure is on a side of another structure away from or adjacent to the substrate 10 both refer to a positional relationship determined by an order of manufacturing each structure during processes of manufacturing the array substrate 100. For example, a fact that the light-shielding electrode 40 is located on the side of the pixel electrodes 20 away from the substrate 10 refers that the pixel electrodes 20 are first formed on the substrate 10, and then the light-shielding electrode 40 is formed on the side of the pixel electrodes 20 away from the substrate 10.

In one embodiment, referring to FIG. 2, the light-shielding electrode 40 is configured to cooperate with the common electrode 30 to form at least some of the slits 301. For example, the intersection of the light-shielding electrode 40 and the common electrode 30 forms a mesh structure. Each of the slits 301 is located in one mesh of the mesh structure. Each of the slits 301 is formed by an enclosure of the light-shielding electrode 40 and the common electrode 30. The slits 301 are hollow patterns formed by the enclosure of the light-shielding electrode 40 and the common electrode 30. Specifically, the common electrode 30 includes the plurality of first electrode lines 31 arranged at intervals along the first direction X. Each of the pixel opening regions PD corresponds to at least one of the first electrode lines 31. Each of the first electrode lines 31 arranged corresponding to the pixel opening regions PD crosses multiple pixel opening regions PD. A line shape of each of the first electrode lines 31 includes at least one of a straight line and a folded line. This embodiment is illustrated by taking the line shape of each of the first electrode lines 31 including the straight line as an example.

The light-shielding electrode 40 includes a plurality of first light-shielding parts 41 arranged at intervals along the first direction X and a plurality of second light-shielding parts 42 arranged at intervals along the second direction Y. The second light-shielding parts 42 are located in a same layer as and cross-connected to the first light-shielding parts 41. The first light-shielding parts 41 are arranged in a one-to-one correspondence to the data lines DL. The second light-shielding parts 42 are arranged in a one-to-one correspondence to the scanning lines SL. In this situation, regions, formed by an enclosure of the first light-shielding parts 41 and the second light-shielding parts 42, are the pixel opening regions PD. The first light-shielding parts 41 and the first electrode lines 31 extend along a same direction. For example, the first light-shielding parts 41 and the first electrode lines 31 both extend along the second direction Y. The mesh structure is formed by an intersection of the first light-shielding parts 41 and the second light-shielding parts 42, and the common electrode 30. Specifically, the mesh structure is formed by an intersection of the first light-shielding parts 41 and the second light-shielding parts 42, and the first electrode lines 31. Each of the slits 301 is located in one mesh of the mesh structure, i.e., each of the slits 301 is formed by an enclosure of the first light-shielding parts 41, the second light-shielding parts 42, and the first electrode lines 31. The slits 301 are hollow patterns formed by the enclosure of the first light-shielding parts 41, the second light-shielding parts 42, and the first electrode lines 31.

Optionally, each of the first electrode lines 31 is located in a middle region of the corresponding one of the pixel opening regions PD, so that sizes of the plurality of slits 301 formed by the enclosure of the first light-shielding parts 41, the second light-shielding parts 42, and the first electrode lines 31 are uniform in each of the pixel opening regions PD. For example, when each of the pixel opening regions PD corresponds to one of the first electrode lines 31, each of the pixel opening regions PD is equally divided by the corresponding one of the first electrode lines 31. That is, each of the first electrode lines 31 is located on a center line of the corresponding one of the pixel opening regions PD. In this situation, two slits 301 formed by the enclosure of the first electrode line 31, the first light-shielding part 41, and the second light-shielding part 42 are symmetrical with respect to the first electrode line 31.

A voltage on the light-shielding electrode 40 is the same as a voltage on the common electrode 30, e.g., the light-shielding electrode 40 may be directly contacted with the common electrode 30 and form an electrical connection. Alternatively, an insulating layer is disposed between the light-shielding electrode 40 and the common electrode 30, and the electrical connection between the light-shielding electrode 40 and the common electrode 30 is formed in a region outside the pixel opening regions PD. Alternatively, the light-shielding electrode 40 and the common electrode 30 are respectively connected to a same electrical signal.

In one embodiment, referring to FIG. 3 and FIG. 4, the common electrode 30 is located on the side of the pixel electrodes 20 away from the substrate 10, and the common electrode 30 is further located on a side of the light-shielding electrode 40 close to the pixel electrodes 20. That is, the common electrode 30 is located between the light-shielding electrode 40 and the pixel electrodes 20. The common electrode 30 is in direct contact with and electrically connected to the light-shielding electrode 40. A film thickness of the common electrode 30 is less than a film thickness of the light-shielding electrode 40.

Next, a specific film layer structure of the array substrate 100 will be described in detail.

Specifically, the array substrate 100 further includes thin film transistors 50 arranged on the substrate 10. The pixel electrodes 20 are located on a side of the thin film transistors 50 away from the substrate 10, and are electrically connected to the thin film transistors 50. Each of the thin film transistors 50 includes an active layer 51 and a source 52. The source 52 is electrically connected to the active layer 51. Moreover, the source 52 is further electrically connected to a corresponding one of the data lines DL. Optionally, the source 52 and the data lines DL are arranged in a same layer and may be arranged integrally. Certainly, each of the thin film transistors 50 further includes a gate and a drain. The gate is electrically connected to a corresponding one of the scanning lines SL. Optionally, the gate and the scanning lines SL are arranged in a same layer and may be arranged integrally. The drain is electrically connected to the active layer 51. Moreover, the drain is further electrically connected to the corresponding one of the pixel electrodes 20.

In the present disclosure, the “same-layer arrangement” is in contrast to the “different-layer arrangement”. The “same-layer arrangement” refers to a fact that at least two different structures are obtained by patterning a film layer formed of a same material during manufacturing processes, and thus the at least two different structures are arranged in a same layer. For example, in the embodiments, the source 52 and the data lines DL are obtained by patterning a same conductive film layer, and thus the source 52 and the data lines DL are arranged in a same layer. Correspondingly, the “different-layer arrangement” refers to a fact that different film layer structures are obtained by patterning film layers formed of different materials during the manufacturing processes. For example, in the present disclosure, the common electrode 30 and the light-shielding electrode 40 are obtained by patterning different conductive film layers, and thus the common electrode 30 and the light-shielding electrode 40 are arranged in different layers.

The array substrate 100 further includes a plurality of insulating layers. The plurality of insulating layers include a gate insulating layer 11, a first interlayer insulating layer 12, a passivation layer 13, a planarization layer 14, and a second interlayer insulating layer 15. The gate insulating layer 11 covers the active layer 51 and the substrate 10. The first interlayer insulating layer 12 covers the gate insulating layer 11. The passivation layer 13 covers the source 52 and the first interlayer insulating layer 12. The planarization layer 14 covers the passivation layer 13. The second interlayer insulating layer 15 covers the pixel electrodes 20 and planarization layer 14. The source 52 is disposed on the first interlayer insulating layer 12. The pixel electrodes 20 are disposed on the planarization layer 14. The common electrode 30 is disposed on the second interlayer insulating layer 15. The light-shielding electrode 40 is disposed on the common electrode 30.

Optionally, the array substrate 100 further includes a color filter layer 60. The color filter layer 60 is disposed on the passivation layer 13. The planarization layer 14 covers the color filter layer 60 and the passivation layer 13. The color filter layer 60 includes a plurality of color filter blocks with different colors, such as red color filter blocks, green color filter blocks, and blue color filter blocks. Each of the pixel opening regions PD corresponds to one of the color filter blocks.

In one embodiment, referring to FIG. 1 to FIG. 5, FIG. 5 is a second schematic plan structural view of the common electrode and the light-shielding electrode according to some embodiments of the present disclosure. Referring to FIG. 5, a difference from the embodiment shown in FIG. 2 is that the light-shielding electrode 40 includes the first light-shielding parts 41 arranged corresponding to the data lines DL, but does not include the second light-shielding parts 42 arranged corresponding to the scanning lines SL. The first light-shielding parts 41 and the first electrode lines 31 form the slits 301. Please refer to the above-mentioned embodiments for other descriptions, and will not be repeated herein.

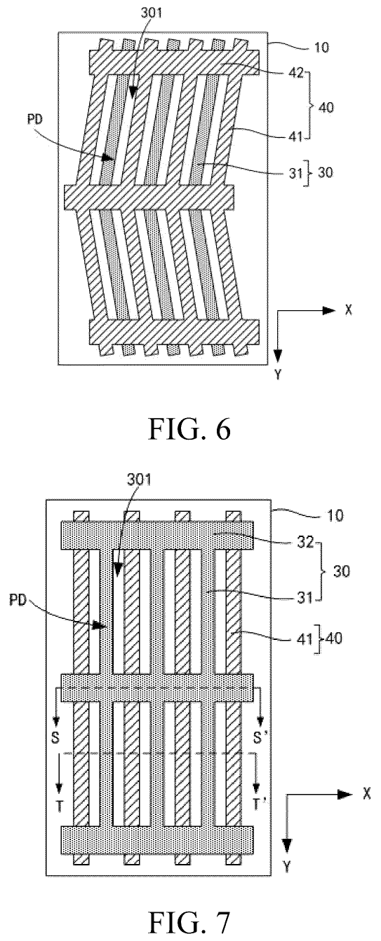

In one embodiment, referring to FIG. 1 to FIG. 6, FIG. 6 is a third schematic plan structural view of the common electrode 30 and the light-shielding electrode 40 according to some embodiments of the present disclosure. Referring to FIG. 6, a difference from the embodiment shown in FIG. 2 is that a line shape of each of the first electrode lines 31 is a folded line, and accordingly, a line shape of each of the first light-shielding parts 41 is also a folded line. Folding points of each of the first electrode lines 31 coincide with folding points of the corresponding one of the first light-shielding parts 41 along the first direction X, and each folding point of each of the first electrode lines 31 and a corresponding folding point of the corresponding one of the first light-shielding parts 41 are located on a corresponding one of the second light-shielding parts 42. Please refer to the above-mentioned embodiments for other descriptions, and will not be repeated herein.

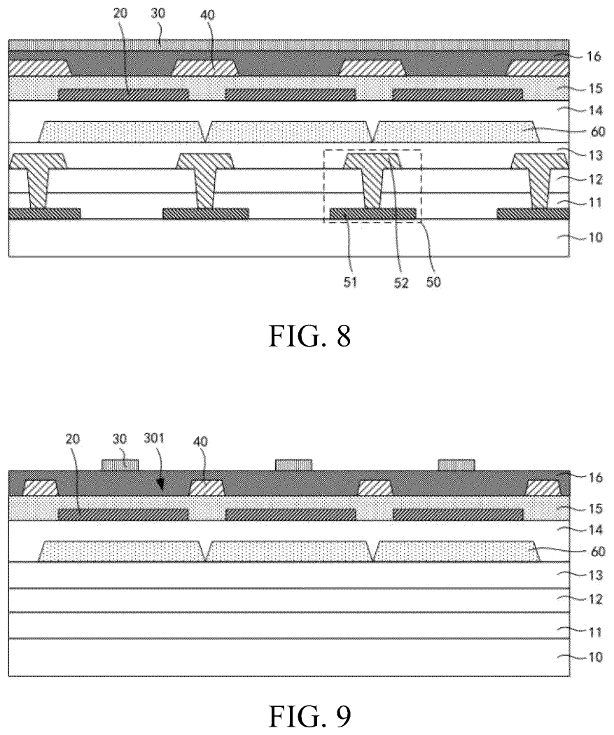

In one embodiment, referring to FIG. 1 to FIG. 9, FIG. 7 is a fourth schematic plan structural view of the common electrode 30 and the light-shielding electrode 40 according to some embodiments of the present disclosure. FIG. 8 is a schematic cross-sectional structural view of the array substrate along a direction shown as S-S′ in FIG. 7. FIG. 9 is a schematic cross-sectional structural view of the array substrate along a direction shown as T-T′ in FIG. 7. Referring to FIG. 7, a difference from the embodiment shown in FIG. 2 is that the common electrode 30 includes the plurality of first electrode lines 31 arranged at intervals along the first direction X and a plurality of second electrode lines 32 arranged at intervals along the second direction Y. The second electrode lines 32 are located in a same layer as and cross-connected to the first electrode lines 31. Each of the pixel opening regions PD corresponds to at least one of the first electrode lines 31. Each of the first electrode lines 31 arranged corresponding to the pixel opening regions PD crosses multiple pixel opening regions PD. At least some of the second electrode lines 32 is arranged corresponding to the scanning lines SL. The light-shielding electrode 40 includes the plurality of first light-shielding parts 41 arranged at intervals along the first direction X. The first light-shielding parts 41 are arranged in the one-to-one correspondence to the data lines DL. In this situation, regions, formed by an enclosure of adjacent two of the first light-shielding parts 41 and adjacent two of the second electrode lines 32, are the pixel opening regions PD.

The mesh structure is formed by an intersection of the first light-shielding parts 41 and the common electrode 30. Specifically, the mesh structure is formed by an intersection of the first light-shielding parts 41, the first electrode lines 31, and the second electrode lines 32. Each of the slits 301 is located in one mesh of the mesh structure. That is, each of the slits 301 is formed by the enclosure of the first light-shielding part 41, the first electrode wire 31, and the second electrode line 32. The slits 301 are hollow patterns formed by the enclosure of the first light-shielding parts 41, the first electrode lines 31, and the second electrode lines 32.

Referring to FIG. 8 and FIG. 9, the common electrode 30 is located on the side of the pixel electrodes 20 away from the substrate 10, and the light-shielding electrode 40 is located on a side of the common electrode 30 adjacent to the pixel. That is, the light-shielding electrode 40 is located between the pixel electrodes 20 and the common electrode 30. The array substrate 100 further includes a first insulating layer 16 located between the common electrode 30 and the light-shielding electrode 40. An electrical connection between the common electrode 30 and the light-shielding electrode 40 is formed in a region outside the pixel opening regions PD, or the light-shielding electrode 40 and the common electrode 30 are respectively connected to the same electrical signal, so that the voltage on the common electrode 30 and the voltage on the light-shielding electrode 40 are the same. Please refer to the above-mentioned embodiments for other descriptions, and will not be repeated herein.

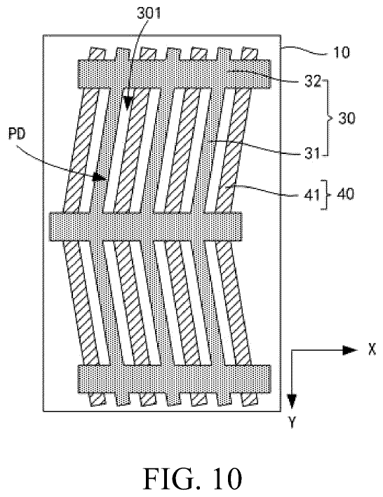

In one embodiment, referring to FIG. 1 to FIG. 10, FIG. 10 is a fifth schematic plan structural view of the common electrode 30 and the light-shielding electrode 40 according to some embodiments of the present disclosure. Referring to FIG. 10, a difference from the embodiment shown in FIG. 7 is that a line shape of each of the first electrode line 31 is a folded line, and accordingly, a line shape of each of the first light-shielding parts 41 is also a folded line. The folding points of each of the first electrode lines 31 coincide with the folding points of the corresponding one of the first light-shielding parts 41 along the first direction X, and each folding point of each of the first electrode lines 31 and a corresponding folding point of the corresponding one of the first light-shielding parts 41 are located on the corresponding one of the second electrode lines 42. Please refer to the above-mentioned embodiments for other descriptions, and will not be repeated herein.

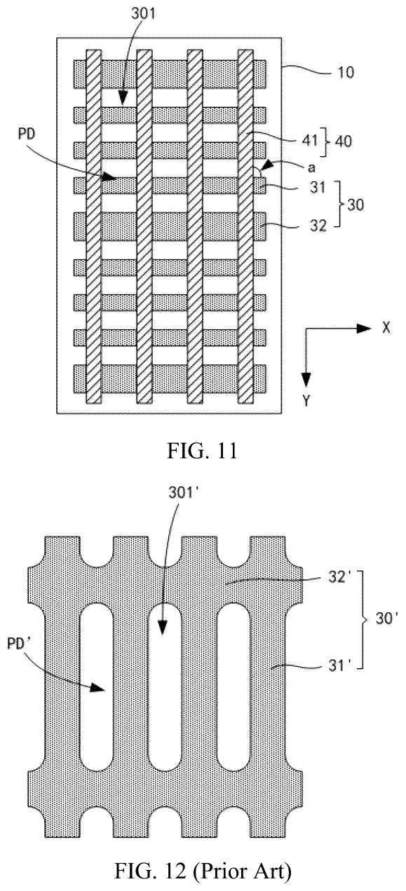

In one embodiment, referring to FIG. 1 to FIG. 12, FIG. 11 is a sixth schematic plan structural view of the common electrode 30 and the light-shielding electrode 40 according to some embodiments of the present disclosure. FIG. 12 is a schematic plan structural view of a common electrode in the related art. Referring to FIG. 11, a difference from the embodiment shown in FIG. 2 is that the common electrode 30 includes the plurality of first electrode lines 31 arranged at intervals along the second direction Y. Each of the pixel opening regions PD corresponds to at least one of the first electrode lines 31. Each of the first electrode lines 31 arranged corresponding to the pixel opening regions PD crosses multiple pixel opening regions PD. The light-shielding electrode 40 includes the plurality of first light-shielding parts 41 arranged at intervals along the first direction X. The first light-shielding parts 41 are arranged in the one-to-one correspondence to the data lines DL. The intersection of the first light-shielding parts 41 and the common electrode 30 forms the mesh structure.

Optionally, the common electrode 30 further includes the plurality of second electrode lines 32 arranged at intervals along the second direction Y. The second electrode lines 32 are arranged in a one-to-one correspondence to the scanning lines and are located between respective adjacent first electrode lines 31. An extending direction of the second electrode lines 32 is the same as an extending direction of the first electrode lines 31, e.g., the second electrode lines 32 and the first electrode lines 31 both extend along the first direction X. Every pixel opening region PD is formed by an enclosure of adjacent two of the second electrode lines 32 and adjacent two of the first light-shielding parts 41. The first electrode lines 31 are located in the respective pixel opening regions PD. The line shape of the first electrode lines 31 and the line shape of the second electrode lines 32 both include at least one of the straight line, the curve, etc. This embodiment is illustrated by taking the line shape of each of the first electrode lines 31 and each of the second electrode lines 32 including the straight line as an example.

An included angle between each of the first electrode lines 31 and the corresponding one of the first light-shielding parts 41 is a first included angle a. The first included angle a ranges from 45° to 90°, e.g., 45°, 50°, 60°, 70°, 80°, 85°, 90°, etc. Each of the first light-shielding parts 41 is arranged in the one-to-one correspondence to the data lines DL, and thus an included angle between each of the first electrode lines 31 and the corresponding one of the data lines DL also ranges from 45° to 90°. When the included angle between each of the first electrode lines 31 and the corresponding one of the first light-shielding parts 41 is 90°, the first electrode lines 31 perpendicularly intersect the first light-shielding parts 41.

The mesh structure is formed by the intersection of the first light-shielding parts 41 and the first electrode lines 31. Each of the slits 301 is located in one mesh of the mesh structure. The slits 301 are formed by an enclosure of the first electrode lines 31 and the first light-shielding parts 41 or an enclosure of the first light-shielding parts 41 and the second electrode lines 32.

In this situation, adjacent two sides of each of the slits 301 are formed by the light-shielding electrode 40 and the common electrode 30, so that the morphology of the corners of the slits 301 is the same as a design value. For example, the corners of the slits 301 are designed to be at right angles, and the actually produced corners of the slits 301 are also at right angles. However, in the related art, referring to FIG. 12, the slits 301′ on the common electrode 30′is formed by an intersection of the first electrode line 31′ and the second electrode line 32′. A region formed by an enclosure of the first electrode lines 31′ and the second electrode lines 32′ is one pixel opening region PD′. One of the slits 301′ corresponds to one of the pixel opening regions PD′. In a high-resolution product, an area of the pixel opening region PD′ is relatively small, and the corners of the slit 301′ are designed as right angles, while the actually produced corners of the slit 301′ are rounded corners. That is, the slits 301′ are designed as rectangles, while the actually produced slits 301′ are ellipses, and thus the morphology of the corners of the slit 301′ changes. Changes of the morphology of the corners of the slit 301′ will change a direction of a local liquid crystal electric field, thereby affecting the deflection of the liquid crystal at four corners of each of the slits 301′, and further affecting the transmittance.

Therefore, compared with FIG. 12, in which the slits 301′ are formed by digging a single layer of the common electrode 30′, the slits 301 in the embodiments of the present disclosure are formed by a double-layer structure of the common electrode 30 and the light-shielding electrode 40 arranged in different layers, and the hole-digging design is not required. In the high-resolution product, the plurality of slits 301 can be formed in the relatively small pixel opening regions PD, and the morphology at the corners of the slits 301 can be optimized. Thus the morphology at the corners of the slits 301 can be relatively clear, the problem of local liquid crystal disorder can be improved, and the transmittance can be improved. Please refer to the above-mentioned embodiments for other descriptions, and will not be repeated herein.

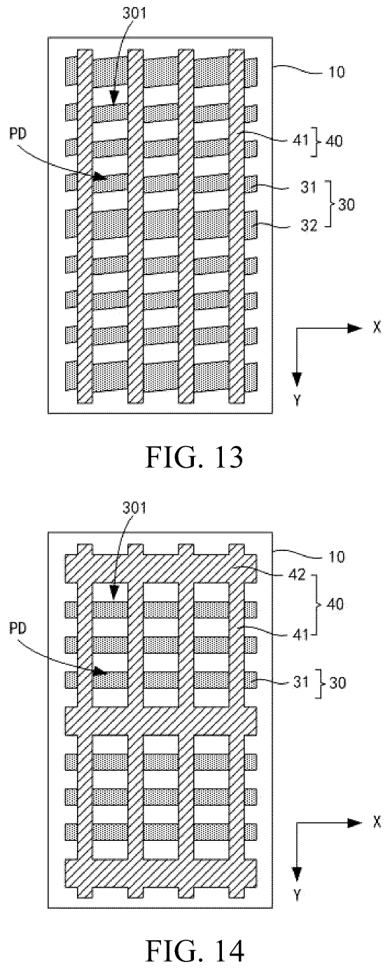

In one embodiment, referring to FIG. 1 to FIG. 13, FIG. 13 is a seventh schematic plan structural view of the common electrode 30 and the light-shielding electrode 40 according to some embodiments of the present disclosure. Referring to FIG. 13, a difference from the embodiment shown in FIG. 11 is that the line shape of each of the first electrode lines 31 and the line shape of each of the second electrode lines 32 are both the curve, thereby improving a response speed of liquid crystals. Please refer to the above-mentioned embodiments for other descriptions, and will not be repeated herein.

In one embodiment, referring to FIG. 1 to FIG. 14, FIG. 14 is an eighth schematic plan structural view of the common electrode 30 and the light-shielding electrode 40 according to some embodiments of the present disclosure. Referring to FIG. 14, a difference from the embodiment shown in FIG. 11 is that the light-shielding electrode 40 further includes second light-shielding parts 42 arranged at intervals along the second direction Y, and the second light-shielding parts 42 are arranged in the one-to-one correspondence to the scanning lines SL. In this situation, the common electrode includes only the first electrode lines 31 arranged at intervals along the second direction Y, and the second electrode lines 32 are not provided.

Specifically, the common electrode 30 includes the plurality of first electrode lines 31 arranged at intervals along the second direction Y. Each of the pixel opening regions PD corresponds to at least one of the first electrode lines 31. Each of the first electrode lines 31 arranged corresponding to the pixel opening regions PD crosses multiple pixel opening regions PD. The light-shielding electrode 40 includes the plurality of first light-shielding parts 41 arranged at intervals along the first direction X and the plurality of second light-shielding parts 42 arranged at intervals along the second direction Y. The second light-shielding parts 42 are located in the same layer as and cross-connected to the first light-shielding parts 41. In this situation, a region formed by the enclosure of the first light-shielding parts 41 and the second light-shielding parts 42 is one pixel opening region PD. The first light-shielding parts 41 are arranged in the one-to-one correspondence to the data lines DL, and the second light-shielding parts 42 are arranged in the one-to-one correspondence to the scanning lines SL.

The mesh structure is formed by the intersection of the first light-shielding parts 41, the second light-shielding parts 42, and the common electrode 30. Specifically, the mesh structure is formed by the intersection of the first light-shielding parts 41, the second light-shielding parts 42, and the first electrode lines 31. Each of the slits 301 corresponds to one mesh of the mesh structure. That is, each of the slits 301 is formed by the enclosure of the first light-shielding parts 41, the second light-shielding parts 42, and the first electrode lines 31. Alternatively, each of the slits 301 is formed by the enclosure of the first light-shielding parts 41 and the first electrode lines 31. Please refer to the above-mentioned embodiments for other descriptions, and will not be repeated herein.

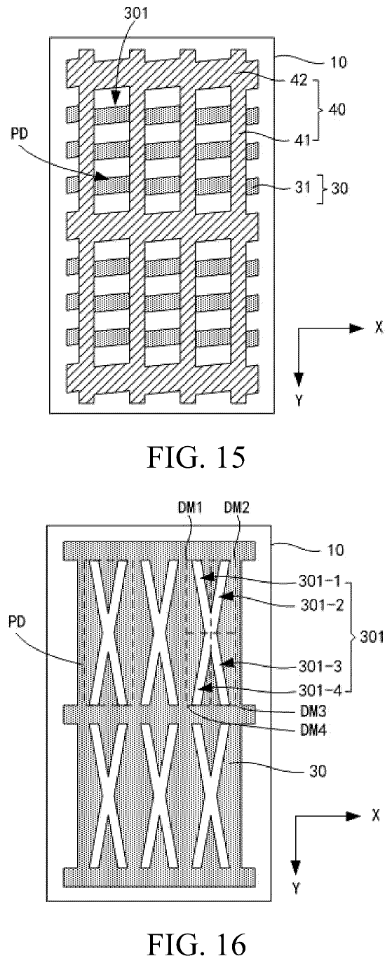

In one embodiment, referring to FIG. 1 to FIG. 15, FIG. 15 is a ninth schematic plan structural view of the common electrode 30 and the light-shielding electrode 40 according to some embodiments of the present disclosure. Referring to FIG. 15, a difference from the embodiment shown in FIG. 14 is that the line shape of each of the first electrode lines 31 is a curve, and accordingly, the line shape of each of the second light-shielding parts 42 is also a curve, thereby improving the response speed of the liquid crystals. Please refer to the above-mentioned embodiments for other descriptions, and will not be repeated herein.

In one embodiment, referring to FIG. 1 to FIG. 16, FIG. 16 is a schematic plan structural view of the common electrode according to some embodiments of the present disclosure. Referring to FIG. 16, a difference from the above-mentioned embodiments is that the slits 301 in each of the pixel opening regions PD are formed by the common electrode 30 alone. Each of the pixel opening regions PD is divided into at least two domain regions. Each of the domain regions is provided with at least one slit 301. The slit 301 in each of the domain regions is formed by partially hollowing out the common electrode 30 in this domain region. The common electrode 30 between two slits 301 in the adjacent two of the domain regions is triangular. Extension directions of the two slits 301 in the adjacent two of the domain regions are different, thereby alleviating a problem of large-viewing-angle deviation.

Specifically, take each of the pixel opening areas PD being divided into four domains, and each of the four domains being provided with one slit 301 as an example to illustrate. The four domain regions are a first domain region DM1, a second domain region DM2, a third domain region DM3, and a fourth domain region DM4, respectively. The first domain region DM1 is provided with a first slit 301-1. The second domain region DM2 is provided with a second slit 301-2. The third domain region DM3 is provided with a third slit 301-3. The fourth domain region DM4 is provided with a fourth slit 301-4. An extending direction of the first slit 301-1 is different from an extending direction of the second slit 301-2 and an extending direction of the fourth slit 301-4. An extending direction of the third slit 301-3 is different from the extending direction of the second slit 301-2 and the extending direction of the fourth slit 301-4.

Optionally, the two slits 301 in the adjacent two of the domain regions are symmetrically arranged, so that the plurality of slits 301 in each of the pixel opening regions PD are uniformly distributed, thereby improving display uniformity. Moreover, at least some of the slits 301 in the adjacent two of the domain regions are cross-communicated to reduce the corners of the slits 301, thereby reducing the risk of local liquid crystal disorder caused by deformation of the corners of the slits 301.

An included angle between the two slits 301 in the adjacent two of the domain regions ranges from 0° to 45° or from 135° to 180°. An included angle between each of the slits 301 and the corresponding one of the data lines DL ranges from 0° to 45°, thereby further alleviating the problem of large-viewing-angle deviation. Please refer to the above-mentioned embodiments for other descriptions, and will not be repeated herein.

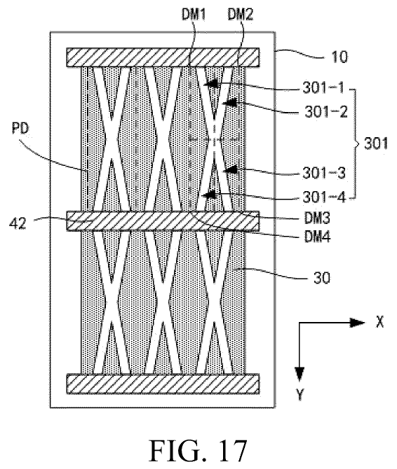

In one embodiment, referring to FIG. 1 to FIG. 17, FIG. 17 is a tenth schematic plan structural view of the common electrode 30 and the light-shielding electrode 40 according to some embodiments of the present disclosure. Referring to FIG. 17, a difference from the embodiment shown in FIG. 16 is that the array substrate 100 further includes the light-shielding electrode 40. The light-shielding electrode 40 includes the plurality of second light-shielding parts 42 arranged at intervals along the second direction Y. The second light-shielding parts 42 are arranged in the one-to-one correspondence to the scanning lines SL. The mesh structure is formed by the intersection of the second light-shielding parts 42 and the common electrode 30. The second light-shielding part 42 forms the slits 301 in cooperation with the common electrode 30. A region surrounded by each of the second light-shielding parts 42 and the two slits 301 in the adjacent two domains is a triangular region. As such, by providing the second light-shielding parts 42 cooperating with the common electrode 30 to form the slits 301, the morphology at the corners of the slits 301 can be optimized, the morphology at the corners of the slits 301 can be relatively clear, and the problem of local liquid crystal disorder can be improved. Moreover, since the second light-shielding parts 42 are provided, the slits 301 in the adjacent two of the pixel opening regions PD arranged along the second direction Y may be communicated. Thus the corners of the slits 301 may further be reduced, and the risk of local liquid crystal disorder caused by deformation of the corners of the slits 301 can further be reduced. Please refer to the above-mentioned embodiments for other descriptions, and will not be repeated herein.

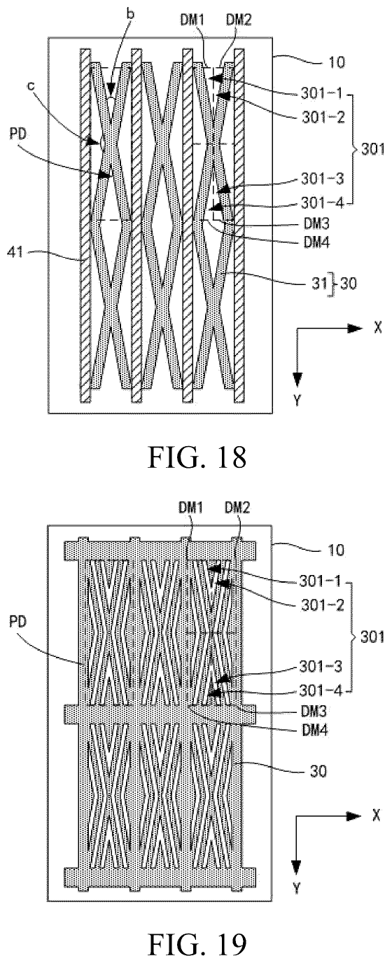

In one embodiment, referring to FIG. 1 to FIG. 18, FIG. 18 is an eleventh schematic plan structural view of the common electrode 30 and the light-shielding electrode 40 according to some embodiments of the present disclosure. Referring to FIG. 18, a difference from the embodiment shown in FIG. 5 is that each of the pixel opening regions PD is divided into at least two domain regions. Each of the domain regions is provided with at least one of the first electrode lines 31. The first electrode lines 31 in adjacent two of the domain regions are symmetrically arranged. The light-shielding electrode 40 includes the plurality of first light-shielding parts 41 arranged at intervals along the first direction X. The first light-shielding parts 41 are arranged in the one-to-one correspondence to the data lines DL. The first electrode lines 31 and the first light-shielding parts 41 form some of the slits 301, and adjacent two of the first electrode lines 31 form another part of the slits 301, so that each of the domain regions is provided with at least two of the slits 301.

Specifically, take each of the pixel opening areas PD being divided into four domains, and each of the four domains being provided with two slits 301 as an example to illustrate. The four domain regions are a first domain region DM1, a second domain region DM2, a third domain region DM3, and a fourth domain region DM4, respectively. The first domain region DM1 is provided with a first slit 301-1. The second domain region DM2 is provided with a second slit 301-2. The third domain region DM3 is provided with a third slit 301-3. The fourth domain region DM4 is provided with a fourth slit 301-4.

Optionally, the slits 301 in the adjacent two of the domain regions are symmetrically arranged, so that the plurality of slits 301 in each of the pixel opening regions PD are uniformly distributed, thereby improving the display uniformity. Moreover, at least some of the slits 301 in the adjacent two of the domain regions are cross-communicated to reduce the corners of the slits 301, thereby reducing the risk of local liquid crystal disorder caused by deformation of the corners of the slits 301, and improving the transmittance.

An included angle between the two first electrode lines 31 symmetrically arranged in adjacent two of the domain regions ranges from 0° to 45° or from 135° to 180°. For example, an included angle between the first electrode line 31 in the first domain region DM1 and the first electrode line 31 in the second domain region DM2 is a second included angle b. The second included angle b ranges from 0° to 45°, e.g., 10°, 20°, 25°, 30°, 35°, 40°, 45°, etc. An included angle between the first electrode line 31 in the first domain region DM1 and the first electrode line 31 in the fourth domain region DM4 is a third included angle c. The third included angle c ranges from 135° to 180°, e.g., 135°, 140°, 145°, 150°, 155°, 160°, 170°, etc. Correspondingly, an included angle between the two slits 301 symmetrically arranged in the adjacent two of the domain regions ranges from 0° to 45° or from 135° to 180°. An included angle between each of the slits 301 and the corresponding one of the data lines DL ranges from 0° to 45°, thereby further improving the problem of large-viewing-angle deviation. Please refer to the above-mentioned embodiments for other descriptions, and will not be repeated herein.

In one embodiment, referring to FIG. 1 to FIG. 19, FIG. 19 is another schematic plan structural view of the common electrode 30 according to some embodiments of the present disclosure. Referring to FIG. 19, a difference from the embodiment shown in FIG. 16 is that each of the domain regions includes a plurality of slits 301, as schematically shown in FIG. 19, three slits 301 are provided in each of the domain regions. Extending directions of three adjacent slits 301 in each of the domain regions are the same. Some of the slits 301 in the adjacent domain regions are communicated, thereby further improving the problem of large-viewing-angle deviation. Please refer to the above-mentioned embodiments for other descriptions, and will not be repeated herein.

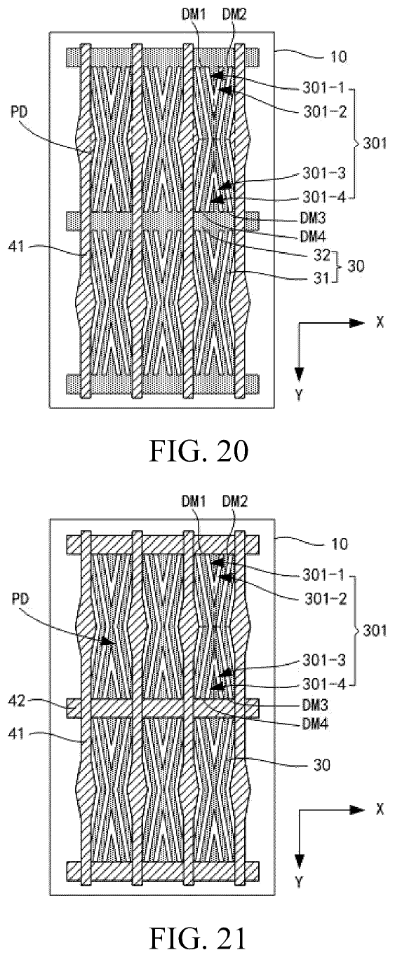

In one embodiment, referring to FIG. 1 to FIG. 20. FIG. 20 is a twelfth schematic plan structural view of the common electrode 30 and the light-shielding electrode 40 according to some embodiments of the present disclosure. Referring to FIG. 20, a difference from the embodiment shown in FIG. 18 is that each of the domain regions is provided with at least two first electrode lines 31. The first electrode lines 31 in adjacent two of the domain regions are symmetrically arranged, and some of the first electrode lines 31 in the adjacent two of the domain regions are connected to each other. The extending directions of the first electrode lines 31 in each of the domain regions are the same, and thus a plurality of slits 301 having the same extending directions are formed in each of the domain regions. Meanwhile, the common electrode 30 further includes the plurality of second electrode lines 32 arranged at intervals along the second direction Y. The second electrode lines 32 are arranged in the one-to-one-correspondence to the scanning lines.

Some of the slits are formed between the first electrode lines 31 and the first light-shielding parts 41, and another ones of the slits are formed between the first electrode lines 31 and the second electrode lines 32. Each of the first light-shielding parts 41 is provided with a protruding part at a position close to a connection point of the adjacent two of the first electrode lines 31, so that the uniform slits 301 are formed between the first light-shielding parts 41 and the first electrode lines 31.

In one embodiment, referring to FIG. 1 to FIG. 21, FIG. 21 is a thirteenth schematic plan structural view of the common electrode 30 and the light-shielding electrode 40 according to some embodiments of the present disclosure. Referring to FIG. 21, a difference from the embodiment shown in FIG. 20 is that the light-shielding electrode 40 further includes second light-shielding parts 42 arranged at intervals along the second direction Y, and the second light-shielding parts 42 are arranged in the one-to-one-correspondence to the scanning lines. In this situation, the common electrode includes only the first electrode lines 31, and the second electrode lines 32 are not provided.

Specifically, the light-shielding electrode 40 includes the plurality of first light-shielding parts 41 arranged at intervals along the first direction X and the plurality of second light-shielding parts 42 arranged at intervals along the second direction Y. The second light-shielding parts 42 are located in the same layer as and cross-connected to the first light-shielding parts 41. The first light-shielding parts 41 are arranged in the one-to-one correspondence to the data lines DL. The second light-shielding parts 42 are arranged in the one-to-one correspondence to the scanning lines SL. The mesh structure is formed by the intersection of the first light-shielding parts 41, the second light-shielding parts 42, and the common electrode 30. By providing the first light-shielding parts 41 and the second light-shielding parts 42 to cooperate with the common electrode 30 to form the slits 301, the morphology at the corners of the slits 301 can be optimized, the morphology at the corners of the slits 301 can be relatively clear, and the problem of local liquid crystal disorder can be improved. Please refer to the above-mentioned embodiments for other descriptions, and will not be repeated herein.

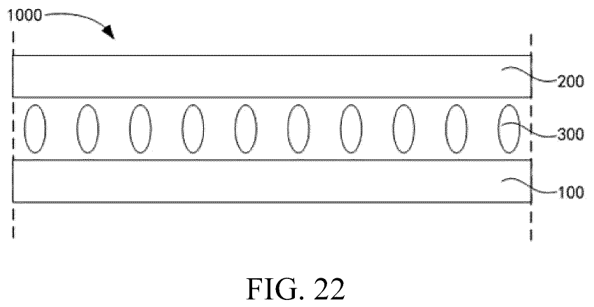

Based on the same inventive concept, a display panel is further provided by the embodiments of the present disclosure. Referring to FIG. 1 to FIG. 22, FIG. 22 is a schematic partial cross-sectional structural view of a display panel according to some embodiments of the present disclosure. The display panel includes the array substrate 100 in any one of the foregoing embodiments. The display panel is a liquid crystal display panel or the like. The embodiments are illustrated by taking the display panel as the liquid crystal display panel as an example. Specifically, referring to FIG. 22, the display panel 1000 includes a first substrate and a second substrate arranged opposite to each other. One of the first substrate and the second substrate is the array substrate 100 of one of the foregoing embodiments. The embodiments are illustrated by taking the first substrate as the array substrate 100 as an example, and thus the second substrate 200 is a color filter substrate. The display panel 1000 further includes liquid crystal molecules 300 sandwiched between the array substrate 100 and the second substrate 200.

As can be seen from the above-mentioned embodiments:

In the array substrate and the display panel provided by the present disclosure. The array substrate includes the substrate and the plurality of data lines, the plurality of scanning lines, the plurality of pixel electrodes, the common electrode, and the light-shielding electrode, which are arranged on the substrate. The intersection of the plurality of scanning lines and the plurality of data lines defines a plurality of pixel opening regions. Each of the pixel electrodes is located in a corresponding one of the pixel opening regions. The common electrode is disposed on the substrate in a pattern. The common electrode and the pixel electrodes are arranged at intervals. The pixel electrodes are located outside the pixel opening regions. The light-shielding electrode is configured to cooperate with the common electrode to form at least some slits. The common electrode includes a plurality of first electrode lines arranged at different layers from the light-shielding electrode. At least one of the first electrode lines passes through the corresponding one of the pixel opening regions in a top view angle of the array substrate, so as to form at least two silts in the corresponding one of the pixel opening regions with the light-shielding electrode. Thus the range of the liquid crystal dark region may be reduced and the bright region is enlarged, thereby improving the transmittance. Moreover, the light shielding electrode and the common electrode arranged in different layers form the slits, and thus the morphology at the corners of the slits can be optimized to be relatively clear, thereby alleviating the problem of the local liquid crystal disorder.

In the foregoing embodiments, the description of each of the embodiments focuses on different aspects. For a part that is not described in detail in an embodiment, reference may be made to relevant descriptions in other embodiments.

The embodiments of the present disclosure are described in detail above. The principle and implementations of the present disclosure are described in this specification by using specific examples. The description about the foregoing embodiments is merely provided to help understand the method and core ideas of the present disclosure. Persons of ordinary skill in the art should understand that they may still make modifications to the technical proposals described in the foregoing embodiments or make equivalent replacements to some or all technical features thereof, without departing from the scope of the technical proposals of the embodiments of the present disclosure.

1. An array substrate, comprising:
a substrate;
a plurality of data lines arranged on the substrate at intervals along a first direction;
a plurality of scanning lines arranged on the substrate at intervals along a second direction, wherein the second direction is different from the first direction, and intersection of the plurality of scanning lines and the plurality of data lines defines a plurality of pixel opening regions;
a plurality of pixel electrodes disposed on the substrate, wherein each of the pixel electrodes is located in a corresponding one of the pixel opening regions;
a common electrode patterned and disposed on the substrate, wherein the common electrode is spaced from the pixel electrodes in a thickness direction of the array substrate; and
a light-shielding electrode patterned and disposed on the data lines and/or the scanning lines and located outside the pixel opening regions, wherein the light-shielding electrode is configured to cooperate with the common electrode to form at least some slits;
wherein the common electrode comprises a plurality of first electrode lines arranged at a different layer from the light-shielding electrode, and at least one of the first electrode lines passes through at least one of the pixel opening regions in a top view angle of the array substrate.

2. The array substrate according to claim 1, wherein the plurality of first electrode lines are arranged at intervals along the first direction, and each of the pixel opening regions corresponds to at least one of the first electrode lines; and
wherein the light-shielding electrode comprises a plurality of first light-shielding parts arranged at intervals along the first direction, the first light-shielding parts are arranged in a one-to-one correspondence to the data lines, and the first light-shielding parts and the first electrode lines form the slits.

3. The array substrate according to claim 2, wherein an extending direction of each of the first electrode lines is the same as an extending direction of a corresponding one of the first light-shielding parts, and a line shape of each of the first electrode lines comprises at least one of a straight line and a folded line.

4. The array substrate according to claim 1, wherein the plurality of the first electrode lines are arranged at intervals along the second direction, and each of the pixel opening regions corresponds to at least one of the first electrode lines; and
wherein the light-shielding electrode comprises a plurality of first light-shielding parts arranged at intervals along the first direction, the first light-shielding parts are arranged in a one-to-one correspondence to the data lines, and the first light-shielding parts and the first electrode lines form the slits.

5. The array substrate according to claim 4, wherein a line shape of each of the first electrode lines comprises at least one of a straight line and a curve.

6. The array substrate according to claim 4, wherein an included angle between each of the first electrode lines and a corresponding one of the first light-shielding parts ranges from 45° to 90°.

7. The array substrate according to claim 1, wherein each of the pixel opening regions is divided into at least two domain regions, each of the domain regions is provided with at least one of the first electrode lines, and the first electrode lines in adjacent two of the domain regions are symmetrically arranged; and
wherein the light-shielding electrode comprises a plurality of first light-shielding parts arranged at intervals along the first direction, the first light-shielding parts are arranged in a one-to-one correspondence to the data lines, and the first light-shielding parts and the first electrode lines form the slits.

8. The array substrate according to claim 7, wherein an included angle between two first electrode lines symmetrically arranged in the adjacent two of the domain regions ranges from 0° to 45° or from 135° to 180°.

9. The array substrate according to claim 2, wherein the light-shielding electrode further comprises a plurality of second light-shielding parts arranged at intervals along the second direction, and the second light-shielding parts are arranged in a one-to-one correspondence to the scanning lines.

10. The array substrate according to claim 2, wherein the common electrode further comprises a plurality of second electrode lines arranged at intervals along the second direction, and the second electrode lines are arranged in a one-to-one correspondence to the scanning lines.

11. The array substrate according to claim 1, wherein the common electrode and the light-shielding electrode are both located on a side of the pixel electrodes away from the substrate, and the common electrode is in direct contact with and electrically connected to the light-shielding electrodes.

12. The array substrate according to claim 1, wherein the common electrode is located on a side of the pixel electrodes away from the substrate, the array substrate further comprises a first insulating layer located between the common electrode and the light-shielding electrode, and a voltage on the common electrode is the same as a voltage on the light-shielding electrode.

13. The array substrate according to claim 1, wherein a material of the common electrode is the same as a material of the pixel electrodes, the material of the pixel electrodes comprises indium tin oxide, and the material of the light-shielding electrode comprises at least one of molybdenum and molybdenum oxide.

14. A display panel, comprising an array substrate, wherein the array substrate comprises:
a substrate;
a plurality of data lines arranged on the substrate at intervals along a first direction;
a plurality of scanning lines arranged on the substrate at intervals along a second direction, wherein the second direction is different from the first direction, and intersection of the plurality of scanning lines and the plurality of data lines defines a plurality of pixel opening regions;
a plurality of pixel electrodes disposed on the substrate, wherein each of the pixel electrodes is located in a corresponding one of the pixel opening regions;
a common electrode patterned and disposed on the substrate, wherein the common electrode is spaced apart from the pixel electrodes in a thickness direction of the array substrate; and
a light-shielding electrode patterned and disposed on the data lines and/or the scanning lines and located outside the pixel opening regions, wherein the light-shielding electrode is configured to cooperate with the common electrode to form at least some slits;
wherein the common electrode comprises a plurality of first electrode lines arranged at a different layer from the light-shielding electrode, and at least one of the first electrode lines passes through at least one of the pixel opening regions in a top view angle of the array substrate.

15. The display panel according to claim 14, wherein the plurality of first electrode lines are arranged at intervals along the first direction, and each of the pixel opening regions corresponds to at least one of the first electrode lines; and
wherein the light-shielding electrode comprises a plurality of first light-shielding parts arranged at intervals along the first direction, the first light-shielding parts are arranged in a one-to-one correspondence to the data lines, and the first light-shielding parts and the first electrode lines form the slits.

16. The display panel according to claim 14, wherein the plurality of the first electrode lines are arranged at intervals along the second direction, and each of the pixel opening regions corresponds to at least one of the first electrode lines; and
wherein the light-shielding electrode comprises a plurality of first light-shielding parts arranged at intervals along the first direction, the first light-shielding parts are arranged in a one-to-one correspondence to the data lines, and the first light-shielding parts and the first electrode lines form the slits.

17. The display panel according to claim 14, wherein each of the pixel opening regions is divided into at least two domain regions, each of the domain regions is provided with at least one of the first electrode lines, and the first electrode lines in adjacent two of the domain regions are symmetrically arranged; and
wherein the light-shielding electrode comprises a plurality of first light-shielding parts arranged at intervals along the first direction, the first light-shielding parts are arranged in a one-to-one correspondence to the data lines, and the first light-shielding parts and the first electrode lines form the slits.

18. The display panel according to claim 15, wherein the light-shielding electrode further comprises a plurality of second light-shielding parts arranged at intervals along the second direction, and the second light-shielding parts are arranged in a one-to-one correspondence to the scanning lines.

19. The display panel according to claim 14, wherein the common electrode and the light-shielding electrode are both located on a side of the pixel electrodes away from the substrate, and the common electrode is in direct contact with and electrically connected to the light-shielding electrodes.

20. The display panel according to claim 14, wherein the common electrode is located on a side of the pixel electrodes away from the substrate, the array substrate further comprises a first insulating layer located between the common electrode and the light-shielding electrode, and a voltage on the common electrode is the same as a voltage on the light-shielding electrode.
